(19) United States
(12) Patent Application Publication
(10) Pub. No.: US 2004/0003341 A1
(43) Pub. Date: Jan. 1, 2004

(54) Method and apparatus for processing electronic forms for use with resource constrained devices

(75) Inventors: Yasser alSafadi, Yorktown Heights, NY (US); Octav Chipara, Bloomington, IN (US); Amr F. Yassin, Ossining, NY (US); Katie Zhu, Croton-On-Hudson, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/176,236

(22) Filed: Jun. 20, 2002

(51) Int. Cl. G06F 15/00

(52) U.S. Cl. 715/500; 715/513

(57) ABSTRACT

A wireless telephone, personal digital assistant (PDA), smart remote control, or other Internet-enabled processing device includes a scalable electronic forms processing engine which supports a designated subset of the W3C recommended XForms standard. The designated subset may be selected for a given device based on the computational and memory capabilities of the device. Advantageously, the invention allows “thin” devices to process electronic forms without requiring implementation of the complete W3C recommended XForms standard.

### BACKGROUND OF THE INVENTION

1. Technical Field

The present invention relates generally to data processing. Specifically, the present invention relates to an XML based scalable forms engine for processing electronic forms over a computer network such as the Internet.

2. Background of the Related Art

A form, whether a sheet of paper or a web page, represents a structured exchange of data. In the context of the Internet, forms are simply a way to enable users to interact with a Web server. There are many reasons one might choose to use forms. The simplest forms are often created to solicit feedback from users. More complicated forms enable users to check their bank account balances, purchase airline tickets, and check their email. On the Web, forms have become commonplace for search engines, polls, surveys, electronic commerce, and even on-line applications.

Currently, extensible hypertext markup language (XHTML) based forms are used to capture a user's input. With XHTML forms, a user can visit a Web page, add information to the page, and submit the page to a Web server. One very common example, taken from c-commerce, is when a user fills in an XHTML form to order items from a shopping list.

FIG. 1 illustrates XHTML code for an exemplary XHTML form which enables customer data to be sent to a server. The input elements 10-12 collect data in text form from the user. The data is then instructed by the form element (not shown) to be passed to a Uniform Resource Locator (URL) to be processed. The URL points to a server application ready to process the data.

One drawback of using XHTML forms to order items over the Web, such as the one shown in FIG. 1, is that the increasingly complex transactions are starting to exceed the limitations of XHTML forms. As e-commerce grows on the Web, so does the need to offer more complex ways to exchange data. For example, company A might want to place a purchase order with company B. However, company A might want to place some conditions on that exchange. Without a common language this process gets difficult and requires complex programming. In addition to the limitations of data exchange, there are other concerns regarding present-day XHTML forms, for example, the inability to separate data from presentation. Current form controls tie presentation closely to the involved data. Although this may not pose a serious problem with simple forms, such as the one in FIG. 1, it can be cumbersome when complex forms are needed to drive e-commerce for major corporations.

Because forms continue to be an important part of the Web, representing the primary means of interactivity used by many Web sites, Web applications and e-commerce solutions have sparked the demand for better web forms with richer interactions. To address this concern, the worldwide web consortium (W3C) has introduced a new three-part standard of Web forms, referred to as XForms 1.0, which is based on extensible markup language (XML). XForms 1.0 allows the creation of a new platform-independent markup language for online interaction between an XForms processor and a remote entity. XForms are the successor to XHTML forms, and benefit from the lessons learned in the years of XHTML forms implementation experience. Additional details on XForms can be found in “XForms—the Next Generation of WebForms” (W3C May 10, 2002), published at http://www.w3.org/MarkUp/Forms, and in “XForms 1.0” (W3C Working Draft 18 Jan. 2002), published at www.w3.org/TR/xforms, each of which is incorporated by reference herein. XForms represents the next generation of forms on the Web. A primary objective of XForms is to separate data from the presentation of the data to a user to overcome the aforementioned shortcomings of XHTML based forms. XForms will be able to separate the user interface from the data and logic, theoretically allowing the same form to be completed by users on a computer desktop, personal digital assistant (PDA), or mobile phone, provided they have sufficient memory and processing capability.

XForms will be able to provide a much richer and presentation independent way of handling interactive Web transactions. By splitting traditional XHTML forms into three parts—data model, instance data, and user interface (presentation)—XForms overcomes the aforestated limitations of XHTML based forms by separating the data and logic of a form from its presentation. In this manner, the form data can be defined independent of how the end-user will interact with the application. This allows for flexible presentation options.

FIG. 2 illustrates generally the separation of the presentation aspects of XForms from the data and logic, and more specifically illustrates how a single device-independent XML non-visible form definition, referred to as the XForms Data Model 22, defining the individual model items, constraints and other run-time aspects of XForms, is capable of working with a variety of standard or proprietary user interfaces, such as the XForms user interface 24, the extensible hypertext markup language (XHTML) interface 26, the wireless markup language (WML) interface 27 and other proprietary interfaces 28.

An XForms engine, based on the recommended XForms 1.0, serves to facilitate processing of an XML document and is configured for compatibility with the entire recommended XForms 1.0, and thus requires relatively large software components. One drawback of the conventional XForms engines is that, given their size, they are not well suited for use with “thin” devices that characteristically have limited processing capability and memory. Such thin devices, may include, for example, personal digital assistants (PDAs), cellular telephones, set-top boxes or other Internet-enabled “thin” processing devices.

A need therefore exists for an XForms engine based on subsets of the W3C XForms 1.0 which is suitable for use with “thin” devices which overcomes the processing and memory limitations characteristic of such devices.

### SUMMARY OF THE INVENTION

The present invention solves one or more of the above-identified problems of the prior art by providing a scalable XForms engine that is suitable for use in “thin” devices, i.e., devices having limited processing and memory constraints. The scalable XForms engine, referred to herein as a micro XForms engine, is scalable in the sense that it incorporates a designated subset of the Worldwide Web Consortium (W3C) XForms 1.0, the designated subset being suitable to the processing and memory constraints of the thin device.

In accordance with one aspect of the invention, XML based electronic forms are made suitable for processing by so-called “thin” devices having limited processing and storage capabilities by incorporating in the limited memory of the thin device the micro XForms engine of the present invention.

A method for processing electronic forms in accordance with the invention includes the steps of processing an extensible mark-up language (XML) document (i.e., an electronic form) using an XForms engine based on a designated subset of a complete XForms 1.0; and utilizing a result of the processing step to output a valid XForms instance document (i.e., a validated and completed electronic form).

A system embodying the invention includes at least one web server (e.g. an eMerchant) in communication with one or more “thin” devices which incorporate the micro XForms engine in the “thin” device memory, to process received XML based electronic forms.

Advantageously, the invention allows memory constrained “thin” devices and other types of memory constrained Internet-enabled devices to process XML based electronic forms by implementing a subset of the recommended XForm 1.0 working standard that is scaled to the memory capacity of the particular thin device. The scalability is in accordance with the memory and other restrictions of the thin device in which it is implemented such that the thin devices can be used to process XML based electronic forms in an efficient manner. It is also contemplated that the present invention is suitable for use with future versions of the XForms standard.

Because the micro XForms engine of the invention is derived as a subset of the recommended XForms 1.0, which is XML based, it retains the benefits from the capabilities provided by XML. That is, the micro XForms engine enables the separation of the presentation aspect of electronic form generation from the data and logic of the form, thus providing data independence. As such, the micro XForms engine is suitable for use in a wide variety of user platforms, including “thin” devices, because the data model is not tied to its presentation. For example, an electronic form could be displayed and filled in on a PC by a HTML user interface, while the same form could be rendered and filled on a wide variety of “thin” devices including a cellular phone that has a WML user interface, or a thin device which includes an interface which supports voice recognition or handwriting recognition. Regardless of which platform is used for the display of an electronic form, the micro XForms engine provides device independence thereby insuring that the underlying XML application can rely on valid input from the form regardless of the user interface employed. Essentially, the micro XForms engine of the present invention takes advantage of the decoupling between the underlying XML based application and the presentation (i.e., user interface) and thus uses a subset of the XML based application so that a thin device may handle the XForm.

### BRIEF DESCRIPTION OF THE DRAWINGS

The invention is further explained by way of example and with reference to the accompanying drawings, wherein:

FIG. 1 illustrates XHTML code for displaying an XHTML form which enables customer data to be sent to a server in accordance with the prior art;

FIG. 2 illustrates the separation of form from presentation in an XML based electronic form processing system in accordance with an embodiment of the prior art;

FIG. 3 shows an example of a processing device in which the micro XForms engine of the present invention may be implemented;

FIG. 4 shows an example of an Internet-based communication system in which the micro XForms engine of the invention may be implemented;

FIG. 5a shows an XForms stack including a number of complete XML based standards, constructed in accordance with the prior art;

FIG. 5b shows an XForms stack including a number of reduced XML based standards, constructed in accordance with the principles of the present invention;

FIG. 6 illustrates the micro XForms engine of the present invention implemented in an Internet network context;

FIG. 7 is a data flow diagram illustrating the data flow associated with creating an XForms model upon receiving an electronic form at a thin device; and

FIG. 8 is an illustrative example of how an XPath binding is realized for binding a UI input field to an XPath expression.

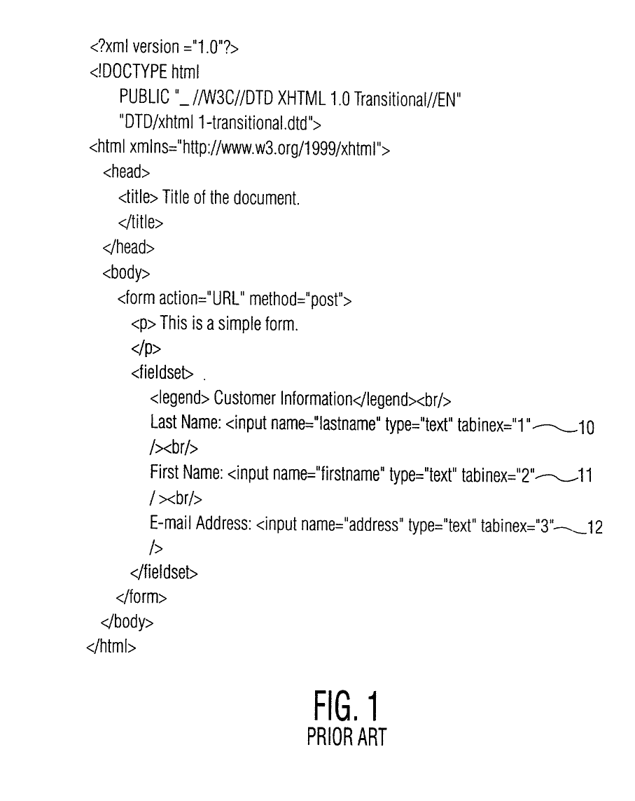

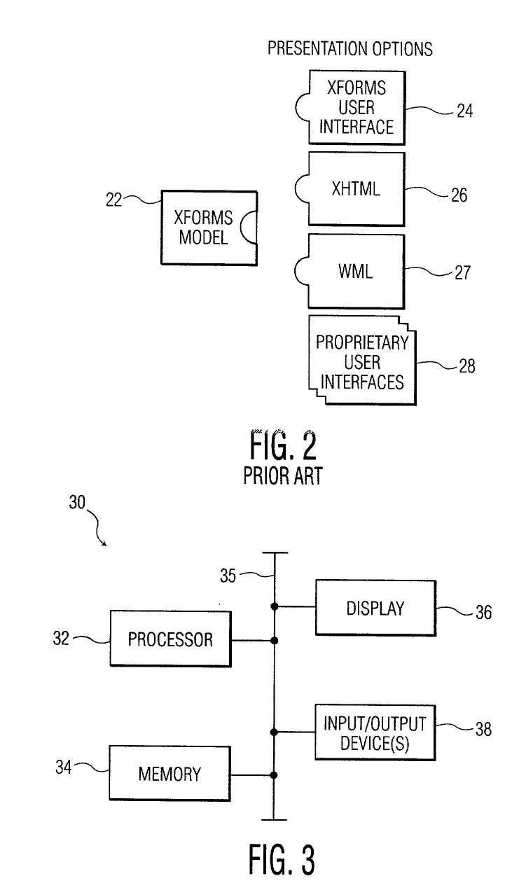

### DETAILED DESCRIPTION OF THE PREFERRED EMBODIMENTS

FIG. 3 shows an example of a processing device 30 in which the micro XForms engine of the present invention may be implemented. The device 30 includes a processor 32 and a memory 34 which communicate over at least a portion of a set 35 of one or more system buses. Also utilizing at least a portion of the set 35 of system buses are a display 36 and one or more input/output (I/O) devices 38. The processing device 30 may represent a “thin” device configured to facilitate e-commerce activity over a wireless or wired network or combination thereof, using well-known protocols such as the Internet Protocol (IP). Such thin devices may include, for example, a wireless telephone, personal digital assistant (PDA), portable computer, smart remote control, or other type of processing device. The so-called thin devices are characterized in that they typically have limited computing power and memory.

The elements of the device 30 may be conventional elements of such devices. For example, the processor 32 may represent a microprocessor, central processing unit (CPU), digital signal processor (DSP), or application-specific integrated circuit (ASIC), as well as portions or combinations of these and other processing devices. The memory 34 is typically an electronic memory, but may comprise or include other types of storage devices, such as disk-based optical or magnetic memory.

The micro XForms engine of the invention described herein may be implemented in whole or in part using software stored and executed using the respective memory 34 and processor 32 elements of the device 30. For example, the micro XForms engine may be implemented at least in part using one or more software programs stored in memory 34 and executed by processor 32. The particular manner in which such software programs may be stored and executed in device elements such as memory 34 and processor 32 is well understood in the art and therefore not described in detail herein.

It should be noted that the device 30 may include other elements not shown, or other types and arrangements of elements capable of providing the scalable XForms processing functions described herein.

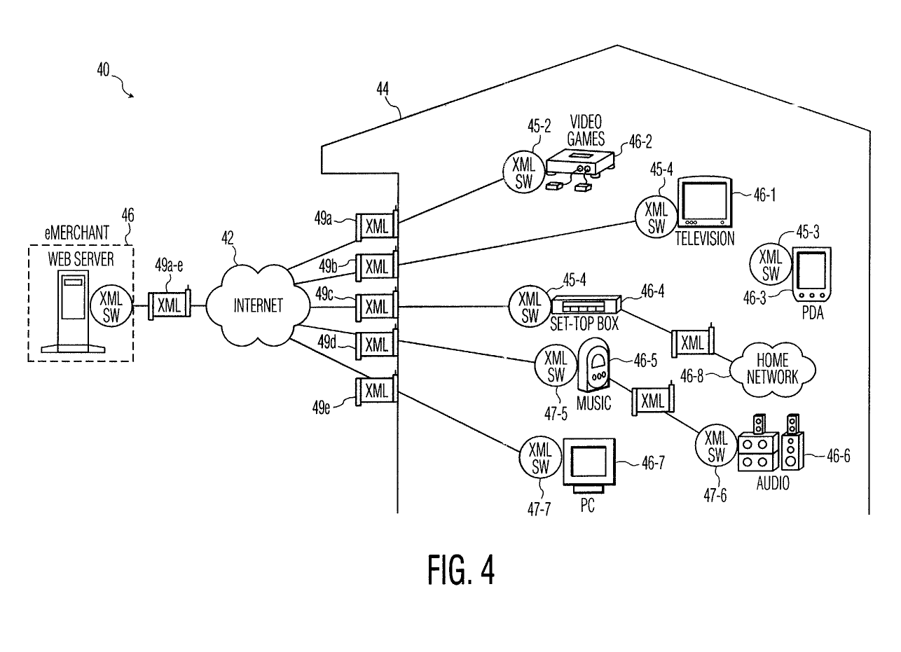

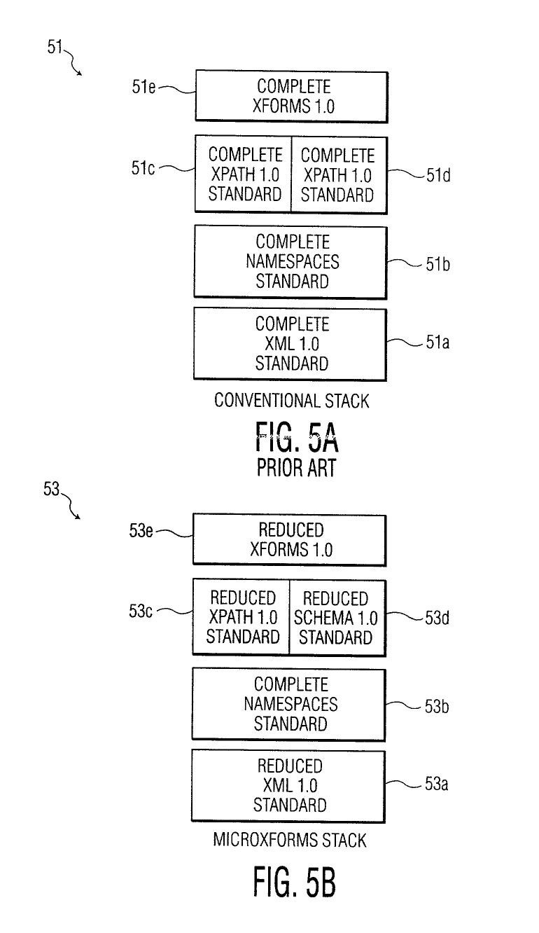

FIG. 4 shows an example of an Internet-based communication system 40 in which the micro XForms engine of the invention may be implemented. The system 40 includes a web server 46 which communicates with a number of devices in a home 44 via the Internet 42. The web server 46 may be associated with an e-commerce merchant (eMerchant). Typically, an e-commerce web server 46 hosts business logic and/or coordinates transactions in providing a service to other processing devices (e.g. thin devices), by delivering XML based documents 49a-49e over the Internet 42 to devices in the home 44, using well-known techniques such as Internet protocol (IP).

The devices in the home 44 in this embodiment are equipped with either the micro XForms engine 45 of the present invention or the complete XForms engine 47 of the prior art based on the complete XForms 1.0. In accordance with a primary objective of the invention, the micro XForms engine 45 is configured for use in thin devices having limited processing and/or memory capabilities. More particularly, the home 44 typically may include the following thin devices: a television set 46-1, a video game console 46-2, a PDA device 46-3 and a set-top box 46-4 which are equipped with respective micro XForms software engines (XML SW) 45-1 through 45-4. The home 44 may also include non-thin devices including: a musical jukebox 46-5, an audio system 46-6, and a PC 46-7 to be interfaced to a home network 46-8. Each of the non-thin devices are equipped with respective complete XForms software engines (XML SW) 47-5 through 47-7. Further, one or more of the thin devices 46-1 to 46-4 may be configured in the manner shown in FIG. 3.

The XML documents 49a-e sent over the Internet 42 from the web server 46 to the devices in home 44 are processed using the corresponding XForms engine 45 or 47. In the case of one of the micro XForms engines 45 of the invention, the XML document 49 is processed using a designated subset of the complete recommended XForms 1.0 in a manner which is compatible with the computation and memory capabilities of the corresponding thin device, thus providing the scalability aspect of the invention.

It should be noted that the particular arrangement and configuration of elements shown in system 40 of FIG. 4 are by way of example only. In other embodiments, other types of web servers, networks and devices may be used. Those skilled in the art will recognize that the micro XForms engine of the present invention which is scalable to a particular thin device does not require any particular arrangement or configuration of such system elements.

FIG. 5a shows a conventional XForms stack 51 including a number of XML based standards including standards given in the complete XML 1.0 standard 51a, a Namespaces standard 51b, an XPath 1.0 standard 51c, a Schema 1.0 standard 51d and a complete XForms 1.0 51c. As is well known, the stack configuration illustratively conveys the idea that stack elements which appear above other stack elements are derived in part from the underlying stack elements.

FIG. 5b shows a reduced XForms stack 53 including a number of reduced ruleset XML based standards corresponding to the XML based standards 51a-e of FIG. 5a. Each standard illustrated in the stack 53, with the exception of the Namespaces standard 53b, represents a designated subset of rules derived from its counterpart standard in the conventional XForms stack 51 of FIG. 5a. The reduced or scaled down standards are used as guidelines for developing the executable code of the micro XForms engine of the present invention for use in the so-called thin devices.

The conventional standards of FIG. 5a and the reduced standards of FIG. 5b are described below. As previously noted, the reduced standards of FIG. 5b are different for different embodiments dependent upon the particular processing and/or memory constraints of the so-called “thin” device. As such, the micro XForms engine is scalable in accordance with the processing and memory restrictions of the device.

Referring initially to the stack 51 of FIG. 5a, there is shown a set of complete XML based standards. Starting at the lowest stack layer, there is shown a complete XML 1.0 standard labeled as element 51a. The XML 1.0 standard 51a defines a standard way to add markup to documents. The complete XML 1.0 working standard 51a does not define either semantics nor a tag set, but rather defines a meta-language (a language used to create other markup languages). The complete XML 1.0 standard 51a provides a facility to define tags and the structural relationships between them. Since there's no predefined tag set, there cannot be any preconceived semantics. All of the semantics of an XML document will either be defined by the applications that process them or by stylesheets. Additional details regarding the complete XML 1.0 standard 51a , can be found in “Extensible Markup Language (XML) 1.0 (second edition)” (W3C recommendation 6 Oct. 2000), published at http://vww.w3.org/TR/REC-xml, which is incorporated by reference in its entirety.

Referring now to FIG. 5b, there is shown the counterpart to the complete XML 1.0 standard 51a of FIG. 5a, labeled the reduced XML 1.0 standard 53a. The reduced XML 1.0 standard 53a, according to one embodiment, incorporates 11 rules from among the 39 rules which define the complete XML 1.0 standard 51a. The rules, according to one embodiment include:

| | | |
|---|---|---|
| [1] document | ::= | element* |
| [2] element | ::= | STag content ETag |
| [3] Stag | ::= | ‘<’QName (Attribute)+‘>’ |
| [4] ETag | ::= | ‘<’/ QName‘>’ |
| [5] content | ::= | element* \| Char* |
| [6] Attribute | ::= | Name ‘=’ ‘ “ ’ Char* ‘ “ ’ |
| [7] Name | ::= | NameChar* |
| [8] NameChar | ::= | Letter \| Digit \| ‘.’ \| ‘-’ \| _’ \| ‘:’ |
| [9] Letter | ::= | [A - Z]\| [a - z] |
| [10] Digit | ::= | ‘0’ \| ‘1’ \| ‘2’ \| ‘3’ \| ‘4’ \| ‘5’ \| ‘6’ \| ‘7’ \| ‘8’ \| ‘9’ |
| [11] char | ::= | Letter \| Digit \| ‘!’ \| ‘#’ \| ‘$’ \| ‘%’ \|‘ |
| | | (’ \| ‘)’ \| ‘*’ \| ‘+’ \| ‘,’ \| ‘-’ \| ‘.’ \| |
| | | /’ \| ‘:’ \| ‘;’ \| ‘=’ \|‘?’ \| ‘@’ \| ‘[’ |
| | | \| ‘\’ \| ‘]’ \| ‘\hat{ }’ \| ‘_’ |
| | | \| ‘'’ \| {’ \| ‘}’ \| ‘˜’ |
| [12] Qname | ::= | (Name‘:’)?Name |

Using the reduced XML 1.0 standard 53a of FIG. 5b provides advantages over using the complete XML 1.0 standard 51a including the avoidance of un-necessary parsing, the provision of a smaller footprint, less memory required during run time and the avoidance of the use of entities and entity references.

Referring again to FIG. 5a, there is shown a complete XML Namespaces standard 51b. The Namespaces standard 51b was created to resolve a problem in XML when different markup languages have elements and attributes that are named the same name. One example of a potential name conflict may occur where a document may use “part” elements to describe parts of books, while another XML document may use “part” elements to describe parts of cars. The XML Namespaces standard 51b tries to improve this situation by extending the data model to allow element type names and attribute names to be qualified with a uniform resource identifier (URI) thus removing the ambiguity. URI's give the local names a global identity to eliminate confusion in distributed environments like the Web. Additional details on Namespaces can be found in “Namespaces in XML” (W3C 14 Jan. 1999), published at http://www.w3.org/TRIREC-xml-names, which is incorporated by reference herein. Due to the exceedingly small footprint of the complete Namespaces standard 51b, the present invention incorporates the Namespaces standard 51b in its entirety without modification (See complete Namespaces standard 53b).

Referring again to FIG. 5a, there is shown the complete XPath 1.0 standard 51c. The complete XPath 1.0 standard 51c defines an XML path language for addressing parts of an XML document, designed for use by both XSLT and XPointer which enable and empower the ability to transform information marked up in XML from one vocabulary to another. Additional details regarding the extensible XPath 1.0 standard 51c can be found in “XML Path Language (XPath) version 1.0” (W3C Recommendation 16 Nov. 1999), published at http://www.w3.org/TR/xpath, which is hereby incorporated by reference in its entirety.

Referring now to FIG. 5b, there is shown the counterpart to the complete XPath 1.0 standard 51c, referred to as the reduced XPath 1.0 standard 53c. While the complete XPath 1.0 standard includes approximately 39 rules, the reduced XPath 1.0 standard 53c, according to one embodiment, incorporates the following subset of rules derived from the complete rule set defined by the complete XPath 1.0 standard 51c:

| | | |
|---|---|---|
| [1] Selector | ::= | Path (‘\|’ Path )* |
| [2] Path | ::= | ‘/’ ( Step (‘/’ \| ‘//’) )* (Step (Number)? \| ‘@’ |
| | | NameTest ) |
| [3] Step | ::= | ‘.’ \| (NameTest \| ‘child::’ NameTest) (‘[’Digits‘]’)? |
| [4] NameTest | ::= | QName \| ‘*’ \| NCName ‘:’ ‘*’ |
| [5] QName | ::= | (NCName‘:’)? NCName |
| [6] NCName | ::= | (Letter \| ‘_’) Char |
| [7] Digits | ::= | [0-9]+ |
| [8] Letter | ::= | [A-Z] \| [a-z] |
| [9] Char | ::= | Letter \| Digit \| ‘!’ \| ‘#’ \| ‘$’ |
| | | \| ‘%’ \| ‘(’]\|‘)’ \| ‘*’ \| ‘+’ |
| | | \| ‘,’ \| ‘-’ \| ‘.’ ‘/’ \| ‘:’ \| ‘;’ \| ‘=’ |
| | | \| ‘?’ \| ‘@’ \| ‘[’ \| ‘\’ \| ]’ \|‘\hat{ }’ |
| | | \| ‘_’ \| ‘'’ \| ‘{’ \| ‘}’ \| ‘˜’ |

The rule subset, defined above, is targeted at only locating a series of nodes. For locating nodes, the following limitations have been imposed: (1) the only available axis is the child axis, (2) the number of predicates is either one or zero, (3) if a predicate is present then the predicate expression (i.e., PredicateExpr) must be an integer denoting the position that the node must be found inside a node-set and (4) the absence of XPath functions (i.e., no mathematical or string operations can be performed).

Incorporating the reduced ruleset above provides advantages over using the entire ruleset. Using only child, descendant and attribute axes instead of the 13 axes in the complete XPath 1.0 Standard 51c, and using only digits instead of expressions or functions for predicates, leads to a major reduction in the XPath software footprint while retaining a majority of the capabilities needed by XPath.

Referring again to FIG. 5a, there is shown a complete XML Schema 1.0 51d. The complete XML Schema 1.0 includes two parts: an XML Schema Part I specification and an XML Schema Part II specification. The XML Schema Part II specification is named XML Schema: Datatypes and it defines facilities for defining data types to be used in XML Schemas as well as other XML specifications.

In general, schemas allow XML documents to be machine validated for accuracy. In other words, a schema, once constructed, allows an XML application to process a document and determine if it adheres to the set of constraints laid out in the schema. Hence, another name for a Schema is a data model. An XML Schema consists of components such as type definitions and element declarations. These can be used to assess the validity of well-formed element and attribute information items and furthermore may specify augmentations to those items and their descendants. Additional details regarding the complete Schema 1.0 standard 51d can be found in “XML Schema Part 2: Datatypes” (W3C Recommendation 02 May 2001), published at http:://www.w3.org/TR/xmlschema-2/, which is incorporated by reference in its entirety.

Referring now to FIG. 5b, there is shown the counterpart to the complete XML Schema 1.0 standard 51d of FIG. 5a, labeled the reduced Schema 1.0 standard 53d. The reduced Schema 1.0 standard 53d, according to one embodiment, includes only a subset of the XML Schema Part II specification related to data types. Thus, in the embodiment, the reduced Schema 1.0 standard 53d incorporates only “Integer” and “String” data types to perform XML document validation. The primary advantage of using the reduced Schema 1.0 standard 53d is that it provides a much smaller footprint. In the embodiment, a sample of data types not included in the reduced Schema standard 53d are: double, float, duration, date, dateTime, time,gYearMonth, gYear, gMonthDay, gDay, gMonth, Boolean, base65binary, hexBinary, QName, NOTATION and anyURI. It is noted that some functionality is sacrificed by not including a full range of data types. For example, not incorporating the ‘date’ data type precludes a capability for performing addition and/or subtraction operations on the field. However as noted, judicious reduction of the footprint allows thin devices to support XForrns while retaining sufficient functionality. Referring again to FIG. 5a, there is shown at a top of the stack a complete XForms 1.0 51e. As shown, by virtue of being at the top of the stack, the complete XForms 1.0 51e is derived in part from each of the underlying standards in the stack 51. The complete XForms 1.0 51e provides a capability to separately describe what the form does from how the form is to be presented to a user. This allows for flexible presentation options, making it possible for classic XHTML form controls, as well as other form control sets such as WML, to be leveraged. XForms allows for the creation of a new platform-independent markup language for online interaction between an XForms Processor and a remote entity. Additional details regarding the complete XForms 1.0 51e can be found in the above cited XForms 1.0 Working Draft of 18 Jan. 2002, http://www.w3.org/TR/xforms/.Referring now to FIG. 5b, there is shown the counterpart to the complete XForms 1.0 51e, referred to as the reduced XForms 1.0 53e. In accordance with the hierarchical organization of the stack, the reduced XForms 1.0 53e is derived in part from each of the underlying standards shown. Accordingly, the reduced XForms 1.0 53e incorporates the limitations of the underlying reduced standards in the stack 53, as described for the embodiments above, for example. In addition to the limitations incorporated from the underlying standards, the reduced XForms 1.0 53e is derived as a reduced rule set from the complete XForms 1.0 51e. The reduced rule set includes a limited number of constraints including static constraints, schema constraints, form control constraints and action constraints. Each constraint type will be described in greater detail as follows.

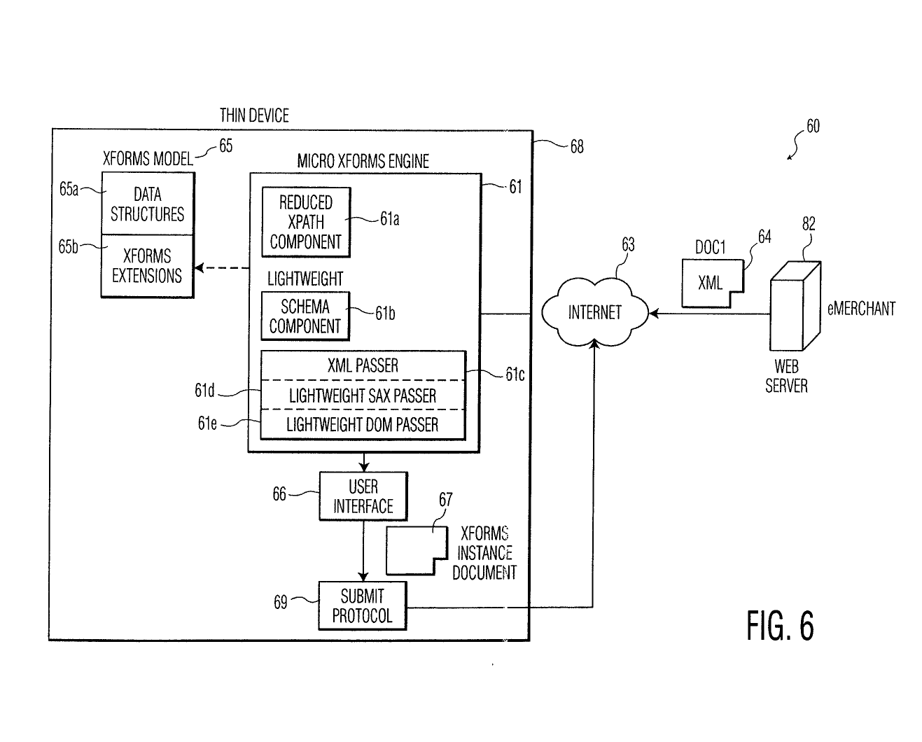

Static constraints are used to define the regulation of the XForms model and define the limitations imposed on the resulting XForms instance document. Examples of some static constraints included in the reduced XForms 1.0 53e include: type, required, minOccurs, maxOccurs, is Valid, calculate and enumeration. Schema constraints are incorporated into the reduced standard to define the details of each element in the XForms model 65 (FIG. 6). An example of an incorporated Schema constraint is the requirement that the number of characters in the name string must be more than one. The third type of constraint incorporated into the reduced XForms 1.0 53e relates to Form Controls. In one embodiment, only “input” and “output” form controls are incorporated into the reduced XForms 1.0 53e. In the reduced standard, the “input” form control is included to permit entry of one line fields like first name and the “output” form control is included to present information already filled in a field of the form, for example, the default country field in an address form. The final constraint type incorporated into the reduced XForms 1.0 53e relates to actions. In one embodiment, “submitInstance” is used to submit a data instance of XForms (i.e., a filled in version of the XForms model).

Using the reduced XForms 1.0 53e provides the advantage of having a capacity to cover a wide range of forms with a smaller implementation of the complete XForms 1.0 51 e.

Processing an Electronic Form

FIG. 6 shows the invention implemented in an Internet network context. In this example, the micro XForms engine 61 of the invention is stored in the memory of a thin device 68, which can be, for example, a PDA or a cellular telephone. The micro XForms engine 61 is shown to be made up of three constituent software components, a reduced XPath software component 61a, a lightweight Schema software component 61b and an XML Parser software component 61c. It is noted that each of the software components 61a-61c which make up the micro XForms engine 61 represent executable code which abides by the limited rulesets defined by one or more of the reduced standards shown in the stack 53 of FIG. 5b.

The micro XForms engine 61 of the present invention is configured for use in thin devices for processing electronic forms over a network, like the Internet. The following description is provided as an illustrative example of the steps involved in processing an electronic form over the Internet using the micro XForms engine 61 of the present invention in a thin device.

With continued reference to FIG. 6, a web server 62, which may be associated with an eMerchant, transmits an XML based electronic form DOC1 64 over the Internet 63 to a thin device 68 including the micro XForms engine 61. The thin device 68 processes the received electronic form DOC1 64 in four stages. The stages for processing an electronic form include displaying the form to a user, filling in the displayed form by the user, validating the filled in form, and submitting the form back to the originator (i.e., web server 62). Each of the stages are described as follows.

Displaying the Electronic Form

Upon receiving the XML document DOC1 64 from the Web server 62 at the thin device 68, the micro XForms engine 61 is tasked with creating the XForms model 65 in the first part of the display stage and displays the XForms user interface 66 in the second part of this stage. The micro XForms engine 61 provides a generic interface for dynamically binding any user interface (UI) 66 with the XForms model 65. Because the micro XForms engine 61 is based on XML technology, it separates the data and logic of a form (e.g., DOC1 64) from its presentation. The display aspects are controlled by the user interface 66 and the data and logic are controlled by the XForms model 65. In this way the form can be defined independent of how the end-user will interact with the form. It is noted, that the user interface 66 is not a lightweight or stripped down version in the thin device 68. Rather, it represents any one of a number of user interfaces for a thin device which are well known in the art including, for example, a WML interface, a voice activated interface, a handwriting interface, a handwriting recognition interface, or an HTML interface. Because XForms separates presentation from the underlying data and logic of the form, the presentation is intelligible whatever the UI of the device. As such, the display aspects controlled by the user interface 66 are not critical to the present invention and as such will not be discussed further.

The XForms model 65 includes two components, a data structures component 65a and an XForms extensions component 65b. The data structures component 65a is essentially a data model which is derived from data included as part of transmitted document DOC1 64. The XForms extensions component 65b is derived from other data included as part of transmitted document DOC1 64 which includes one or more constraints and/or data dependencies to be used in association with the derived data model. The XForms model 65 is constructed by the micro XForms engine 61 from the provided data at the thin device (i.e., the client), as described below. Afterwards, the constructed data structures component 65a is validated against a Schema which is a set of constraints or rules for the class of documents to be transmitted between the eMerchant and the thin device. In the presently described embodiment, the Schema is a reduced Schema 1.0 standard 53d, which includes only a subset of the XML Schema Part II specification, as discussed above. The subset of the XML Schema Part II provides a diversity of data types that a user provided data value can be validated against. For example, in a form which includes a field for age, the schema may specify that the age is a three digit non-negative integer. Once the constructed data structures component 65a is validated against the Schema, it is used by the micro XForms engine 61 in conjunction with the XForms extensions component 65b, which includes a number of constraints which must be adhered to by the various data fields, to build the instance document 67 from user provided input data. One example of a static constraint which may be imposed by the XForms extensions 65b, is that the “zip code” field must be 5 digits. An example of a dynamic constraint which may be imposed, is that if a patient specifies his gender as male, then he cannot indicate that he is pregnant. The instance document 67 is then validated prior to submitting it back to an origin server (e.g., an Emerchant), as will be described below.

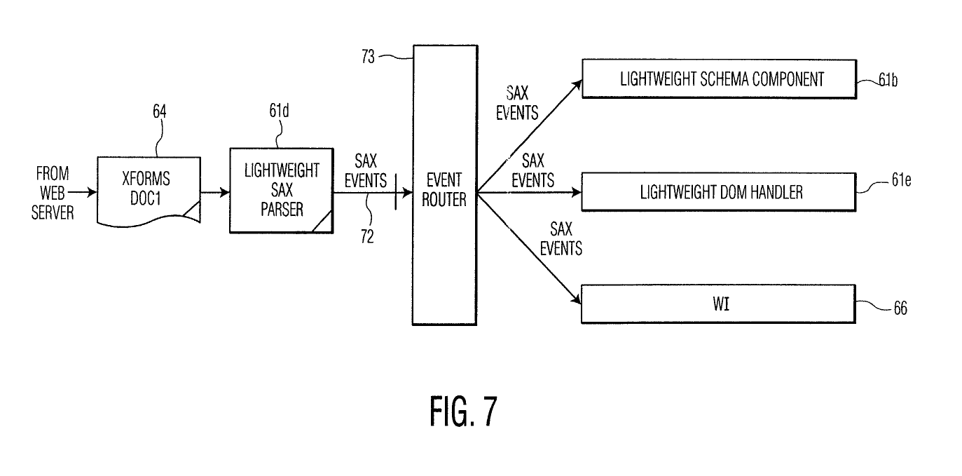

FIG. 7 is a general flow diagram for illustrating the steps associated with creating the XForms model 65 and creating an XForms instance document 67 by components of the micro XForms engine 61. The process of displaying an electronic form begins with the received XML document DOC1 64 being parsed by a lightweight SAX parser 61d, which is one of the software components of the XML Parser 61c, which in turn is a software component of the micro XForms engine 61. SAX, which stands for “simple appliation programming interface” or “simple API”, is a standard programming interface designed for parsing XML documents through an event based architecture. That is, SAX is a type of event callback interface whereby an application developer implements a set of “callback” methods or routines, each of which corresponds to an event which can occur during parsing of an XML document instance. Essentially, the SAX parser provides support for triggering events on all of the standard content in an XML document. A SAX parser's function is to read in an XML document and trigger events based on the things it encounters in the XML document, not operate on the content of the document. SAX events are triggered in response to the following XML document content: open or close element tags, PCDATA and CDATA sections, processing instructions, comments and entity declarations.

Referring still to FIG. 7, the lightweight SAX parser 61d triggers SAX events 72 from parsing the received document DOC1 64 (i.e., electronic form). As generally described above, the lightweight SAX parser 61d is an interface for event-based parsing of XML documents (e.g., DOC1 64). The lightweight SAX parser 61d is a software module constructed in accordance with the complete rule set of the Namespaces standard 53b and the reduced rule set of the reduced XML 1.0 standard 53a, as previously described in FIG. 5b. More detailed information about SAX can be found at http://www.megginson.com/SAX/indcx.html and embedded links therein, which are incorporated by reference herein.

An EventRouter 73 incorporated in the XML parser 61c (but not separately shown in FIG. 6) initially captures the SAX events 72 triggered by the lightweight SAX parser 61d. It is the function of the EventRouter 73 to pass the SAX events 72 to the lightweight Schema component 61b or to a lightweight DOM (Document Object Module) Handler 61e or to the user interface 66 based on the context of the particular SAX event. It is noted that the lightweight Schema component 61b is a software module constructed in accordance with the reduced rule set of the reduced Schema 1.0 standard 53d, as described above. It is further noted that the lightweight DOM handler 61e is responsible for the building of the XForms Instance Document 67. The lightweight DOM handler 61e uses the complete Namespaces standard 53b but, because the Instance Document 67 is based on the reduced XML 1.0 standard 53a and reduced XForms 1.0 53e, the lightweight DOM 61e minimizes the amount of information stored for each element in the Instance Document 67.

After the EventRouter 73 determines the entity responsible for dealing with a given SAX event, the event is passed to the appropriate entity. The XForms model 65 is built based on the events passed to the lightweight schema component 61b. The XForms instance document 67 is built based on events passed to the lightweight DOM parser 61e. Thus, if a valid XForms document DOC1 64 was provided as input, at the conclusion of the displaying step, the XForms model 65 will have been constructed. Otherwise, an exception is triggered.

The EventRouter 73 also routes SAX events received for presentation to the UI 66. As noted, because the presentation data of an XML based form is separate from the data and logic of the form, the entire presentation is routed to the thin device UI 66 for processing and display in a manner applicable to the device.

Filling Out the Electronic Form

At a next stage, the process of filling out the form by the user is performed. When the user fills in a UI input field of a displayed XML document DOC1 64, the value of the corresponding element also changes in the XForms instance document 67. This occurs as a result of each UI input field being linked to an XPath expression via XPath binding. XPath addresses how nodes inside an XML document (e.g., DOC1 64) are accessed. In general, a “binding” connects an instance data node to a form control or to a model item constraint by using a binding expression as a locator.

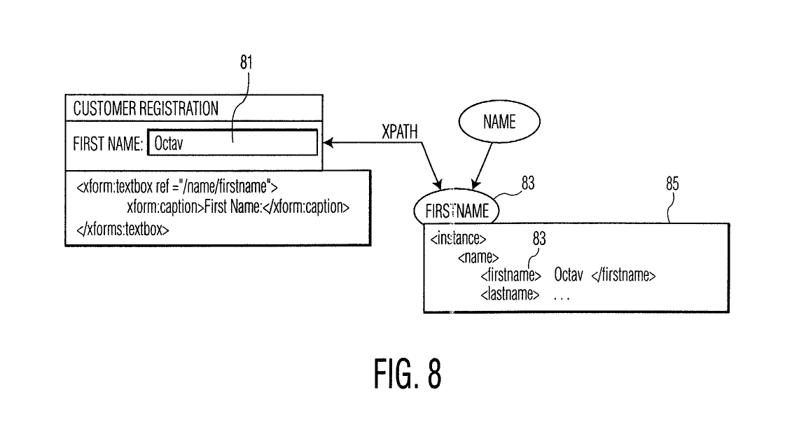

FIG. 8 is an illustrative example of how an XPath binding is realized for binding a UI input field to an XPath expression. In the illustrated example, the textbox 81 containing the expression “Octav” is associated with the element “firstname” 83 in the XForms data instance 85 using the XPath expression “/name/firstname”. XPath is a binding language between the UI component 81 and the XForms data instance 85.

The reduced XPath component 61a of the micro XForms engine 61 of the present invention as described above with respect to FIG. 5b performs the XPath binding operations to connect corresponding data instance nodes inside the XML document with form controls.

Validating the Electronic Form

At any point during the filling of a form the validation process can be started. The validation process consists of checking the information found in the XForms instance document 67 against the XForms Model 65 constructed by the micro XForms engine 61.

As discussed above, due to memory constraints support is provided for only a subset of the XML Schema Part II specification in the lightweight Schema component 61b, which is previously used to validate the XForms Model Data Structure component 65a. As such, the micro XForms engine 61 only checks if the value of a particular element of the Xform instance document 67 is valid with regard to a specified data type. To check if an XForms Instance Document 67 is valid against the XForms Model 65 previously constructed, the following steps are followed:

While traversing the DOM tree in post-order:

If the element contains text information then the information is normalized and if

a) For that element no data type is specified then the data instance is invalid.

b) For that element a data type is specified then the XForms instance document is checked against the type constraints defined in the XForms Model. If the constraints are satisfied then continue. Otherwise, the XForms instance document is invalid.

If the element does not have any children (leaf node in the tree) it must be typed.

If it is not typed then the XForms instance document is invalid.

If all the nodes have been traversed and no error had occurred than the XForms instance document is valid.

By providing only a subset of the complete XML Schema Part II specification for creating the XForms model 65, against which the XForms instance document is checked, an opportunity exists to create an invalid document. The possibility of this undesirable circumstance occurring, however, is balanced by the ability to conform to the processing and memory constraints of a thin device by having to store only a limited subset of the XML Schema specification therein.

Submission

As discussed above, the XForms data instance 67 is sent back to the web server 62 during the process of submission. Any well-known data transport protocol can be used to submit the data instance 67. For example, the HTTP and SOAP transport protocols are used together. The submission step does not involve any actions on the part of the micro XForms engine 61 and will not be discussed in further detail.

It is thus shown that the micro XForms engine 61 of the present invention is scalable for use with thin devices characterized by their processing and memory requirements constraints. As such, the micro XForms engine 61 is suitable for use on a wide range of platforms including, for example, personal digital assistants (PDAs), cellular telephones, set-top boxes or other Internet-enabled “thin” processing devices.

Although illustrative embodiments of the present invention have been described herein with reference to the accompanying drawings, it is to be understood that the invention is not limited to those precise embodiments, but rather it is intended that the scope of the invention is as defined by the scope of the appended claims.

What is claimed is:

1. A method for processing information in a device having limited processing and memory capabilities, the method comprising the steps of:
processing an extensible mark-up language (XML) document using an XForms engine based on a designated subset of a complete XForms specification; and
utilizing a result of the processing step to create a valid XForms instance document.

2. The method according to claim 1, wherein the processing step comprises the steps of displaying, filling, validating and submitting the XForms instance document.

3. The method according to claim 2, wherein the displaying step comprises displaying user interface (UI) components corresponding to the device, said displayed components being decoupled from underlying data included in said instance document.

4. The method according to claim 3, wherein the user interface component is one of a WML user interface, an HTML interface, a user interface that supports voice recognition and a user interface that supports handwriting recognition.

5. The method according to claim 1, wherein the XForms engine is a scalable engine suitable for implementing a plurality of different subsets of the complete XForms specification as a function of the memory and processing capabilities of the device.

6. The method according to claim 1, wherein the device is selected from the group consisting of a wireless telephone, a personal digital assistant, a remote control device, a set-top box and a game console.

7. The method according to claim 1, wherein the XForms engine is constructed from at least one selected from the group of a first subset of rules defined in a recommended XPath standard, a second subset of rules defined in a recommended Schema standard and a third subset of rules defined in a recommended XML standard.

8. The method according to claim 7, wherein the third subset of rules comprises one or more of the following elements:

| | | |
|---|---|---|
| [1] document | ::= | element* |
| [2] element | ::= | STag content ETag |
| [3] Stag | ::= | ‘<’ QName (Attribute)+ ‘>’ |
| [4] ETag | ::= | ‘</’ QName ‘>’ |
| [5] content | ::= | element* \| Char* |
| [6] Attribute | ::= | Name ‘=’ ‘“’ Char* ‘ ”’ |
| [7] Name | ::= | NameChar* |
| [8] NameChar | ::= | Letter \| Digit \| ‘.’ \| ‘-’ \| ‘_’ \| ‘:’ |
| [9] Letter | ::= | [A-Z] \| [a-z] |
| [10] Digit | ::= | ‘0’ \| ‘2’ \| ‘3’ \| ‘4’ \| ‘5’ \| ‘6’ |
| | | \| ‘7’ \| ‘8’ \| ‘9’ |
| [11] Char | ::= | Letter \| Digit \| ‘!’ \| ‘#’ \| ‘$’ \| ‘$’ |
| | | \| ‘%’ \| ‘(’ \| ‘)’ \| ‘*’ \| ‘+’ \| |
| | | ‘,’ \| ‘-’ \| ‘.’ \| ‘/’ \| ‘:’ \| ‘;’ |
| | | \| ‘=’ \| ‘?’ \| ‘@’ \| ‘[’ \| ‘\’ |
| | | \| ‘]’ \| ‘\hat{ }’ \| ‘_’ \| ‘'’ \| |
| | | ‘{’ \| ‘}’ \| ‘˜’ |
| [12] Qname | ::= | (Name‘:’)?Name |

9. The method according to claim 7, wherein the first subset of rules comprises one or more of the following elements

| | | |
|---|---|---|
| [1] Selector | ::= | Path (‘\|’ Path )* |
| [2] Path | ::= | ‘/’ ( Step (‘/’ \| ‘//’) )* ( Step \| ‘@’ NameTest ) |
| [3] Step | ::= | ‘.’ \| (NameTest \| ‘child::’ NameTest) (‘[’Digits‘]’)? |
| [4] NameTest | ::= | QName \| ‘*’ \| NCName ‘:’ ‘*’ |
| [5] QName | ::= | (NCName ‘:’)? NCName |
| [6] NCName | ::= | (Letter \| ‘_’) Char |
| [7] Digits | ::= | [0-9]+ |
| [8] Letter | ::= | [A-Z] \| [a-z] |
| [9] Char | ::= | Letter \| Digit \| ‘!’ \| \| ‘#’ |
| | | \| ‘$’ \| ‘%’ \| ‘(’ \| ‘(’ \| ‘)’ \| ‘*’ |
| | | \| ‘+’ \| ‘,’ \| ‘-’ \| ‘.’ ‘/’ \| ‘:’ |
| | | \| ‘;’ \| ‘=’ \| ‘?’ \| ‘@’ \| ‘[’ \| ‘\’ |
| | | \| ‘]’ \| ‘\hat{ }’ \| ‘_’ \| ‘'’ \| ‘{’ |
| | | \| ‘}’ \| ‘˜’ |

10. An apparatus for processing a document in an extensible markup language, the apparatus comprising:
an XForms engine operable to process the document based on a designated subset of a subset of a complete XForms specification, wherein a result of the processing by the XForms engine is utilized to output a valid XForms instance document.

11. The apparatus of claim 11, wherein the XForms engine comprises a reduced XPath component, a lightweight Schema component and an XML Parser component.

12. An article of manufacture comprising a machine-readable storage medium containing one or more software programs for processing information an extensible markup language (XML), said article of manufacture suitable for use in a thin processing device configured to support a designated subset of a complete set of XML standards, wherein the one or more software programs when executed:
processes an extensible mark-up language (XML) document using an XForms engine based on a designated subset of a complete XForms specification; and
utilizes a result of the processing to create a valid XForms instance document.

13. A system for processing information in a device having limited processing and memory capabilities, the system comprised of:
a) at least one originating device that provides an extensible based markup language (XML) based document to said device; and
b) a processing device configured to process said received XML based document, said processing device including an XForms engine based on a designated subset of a complete XForms specification.

14. The system of claim 13, wherein said XForms engine is comprised of an XPath software component, a lightweight Schema software component and a reduced XML parser component.

15. The system of claim 13, wherein said XForms engine is further comprised of a user interface software component.
